(19) United States
(12) Patent Application Publication
(10) Pub. No.: US 2013/0127255 A1
(43) Pub. Date: May 23, 2013

(54) CONTACTLESS POWER SUPPLYING DEVICE

(71) Applicant: Panasonic Corporation, Osaka (JP)

(72) Inventor: Toyohiko Tsujimoto, Osaka (JP)

(73) Assignee: Panasonic Corporation, Osaka (JP)

(21) Appl. No.: 13/660,904

(22) Filed: Feb. 7, 2013

(30) Foreign Application Priority Data
Jul. 15, 2011 (JP) 2011-156875

(51) Int. Cl. H04B 5/00

(52) U.S. Cl. CPC H04B 5/0037; H04B 5/0087
USPC 307/104

(57) ABSTRACT

A user can be notified with an indicator of information related to a power supplying device. More specifically, the user can be notified by the activation of an LED that nothing is arranged on a power supplying surface. Further, the user can acknowledge from activation of two LEDs that a power receiving device or the like is arranged on the power supplying surface and that the presence of the power receiving device is recognized by the power supplying device. The use can also acknowledge from the activation of an LED that a foreign object of metal or the like is located between the power supplying device and the power receiving device. Further, the user can acknowledge from the activation of LEDs the power supplying coil that is being supplied with power.

### TECHNICAL FIELD

The present invention relates to a contactless power supplying device that supplies a power receiving device with power in a contactless manner.

### BACKGROUND ART

In the prior art, there is a contactless power supplying system that supplies power in a contactless manner from a power supplying device to a power receiving device (for example, refer to Japanese Laid-Open Patent Publication No. 2003-204637). The power supplying device supplies power from a power source in a contactless manner to the power receiving device. When receiving power from the power supplying device, the power receiving device supplies the power to a main body of an electric appliance.

To improve convenience for a user, a free layout type contactless power supplying system has recently been developed. The system allows for a power receiving device to be arranged at any location on an upper surface (power supplying surface) of a power receiving device. A plurality of primary coils are laid out along the power supplying surface in the power supplying device of the system. The power supplying device excites the primary coils in the area where the power receiving device is located and uses electromagnetic induction to supply power to the power receiving device (for example, refer to Japanese Laid-Open

### SUMMARY OF THE INVENTION

### Problems that are to be Solved by the Invention

In the free-layout type contactless power supplying system, when setting the power receiving device on the power supplying surface, there is no way for the user to know whether or not the power receiving device has been recognized in a normal manner by the power supplying device and whether or not the power receiving device is being supplied with power in a normal manner. In this manner, the user cannot acknowledge the present situation of the power supplying device. Accordingly, to check whether or not power is being supplied in a normal manner, the user has to check the charge state of, for example, a portable terminal.

It is an object of the present invention to provide a contactless power supplying device that can notify a user of the state of a contactless power supplying device.

### Solution to the Problems

To achieve the above object, the present invention provides a contactless power supplying device including a power supplying surface on which a power supplying device is set. A plurality of power supplying coils are arranged along the power supplying surface. Among the power supplying coils, power supplying coils opposing the power receiving device set on the power supplying surface are supplied with alternating current to generate magnetic flux used for electromagnetic induction that supplies power in a contactless manner to the opposing power supplying coils. A notification unit generates a notification of information related to the contactless power supplying device.

### Effect of the Invention

The present invention allows for a user to be notified of the state of a contactless power supplying device.

### BRIEF DESCRIPTION OF THE DRAWINGS

FIG. 1 is a diagram showing a contactless power supplying system of a first and second embodiment.

FIG. 2 is a perspective view showing the power supplying device of the first embodiment.

FIG. 3 is a perspective view showing a state in which a portable terminal is arranged on a power supplying surface in the first embodiment.

FIG. 4 is a front view showing an indicator in the first embodiment.

FIG. 5 is a flowchart executed by a common control circuit in the first embodiment.

FIG. 6 is a front view showing an indicator in the second embodiment.

FIG. 7 is a flowchart executed by a common control circuit in the second embodiment.

### EMBODIMENTS OF THE INVENTION

### First Embodiment

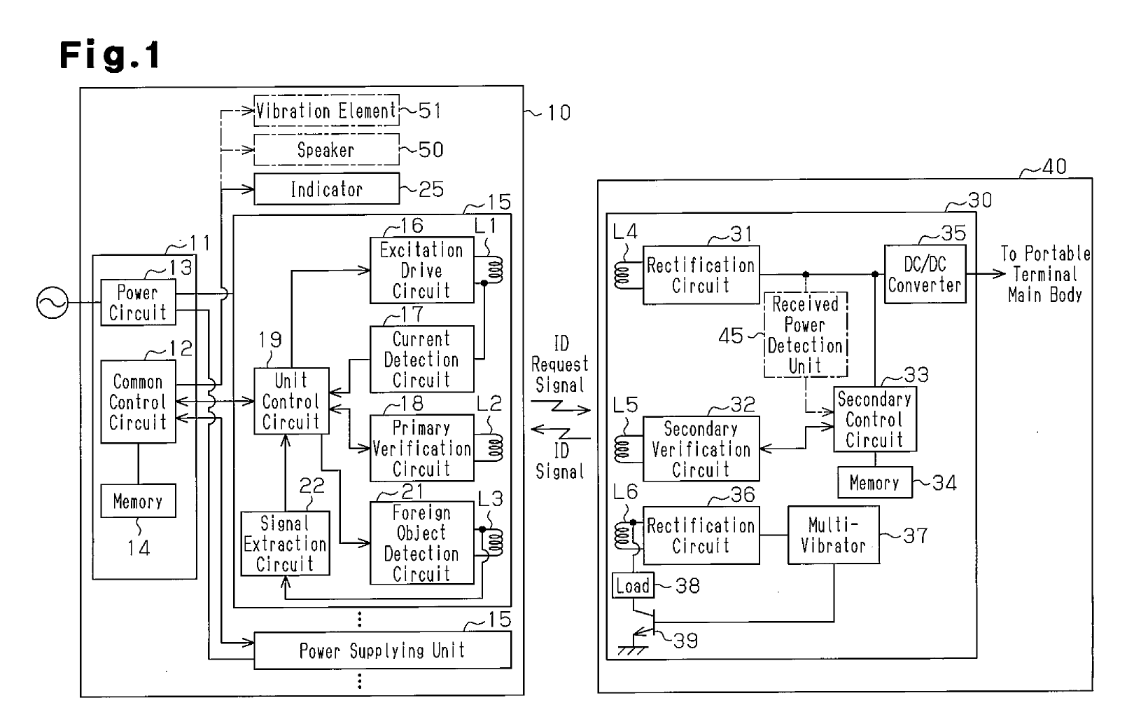

A first embodiment of a contactless power supplying device according to the present invention applied to a contactless power supplying system will now be described with reference to FIGS. 1 to 5.

As shown in FIG. 1, the contactless power supplying system includes a power supplying device 10 and a power receiving device. In the present example, the power receiving device 30 is incorporated in a portable terminal 40. The structure of the power supplying device 10 and the power receiving device 30 will now be described in detail.

Power Supplying Device

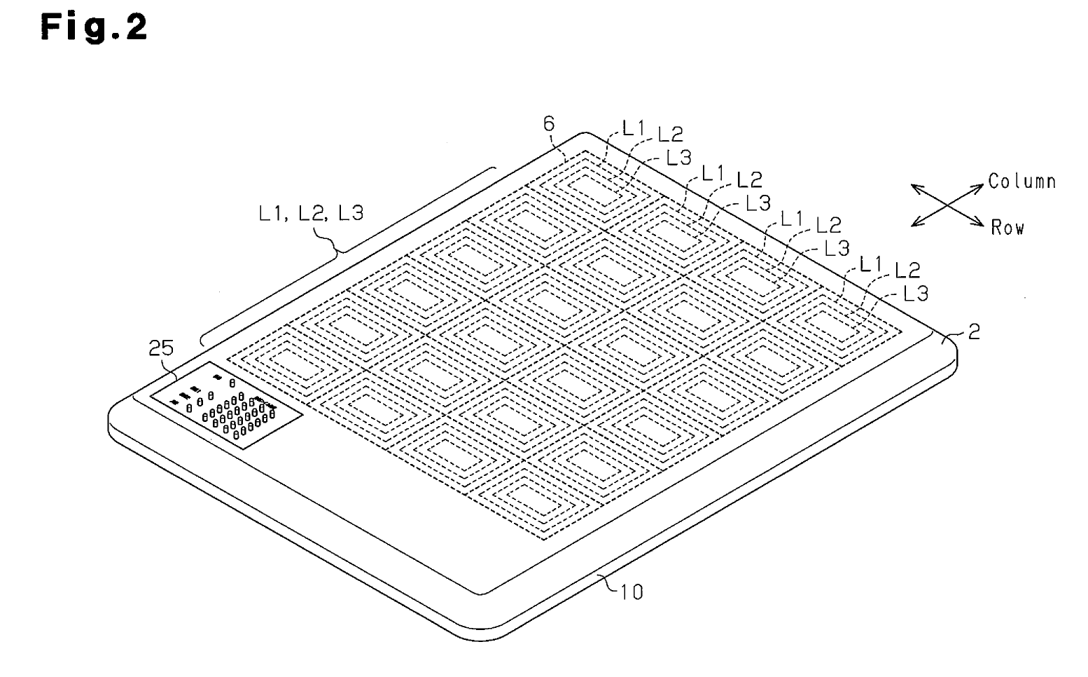

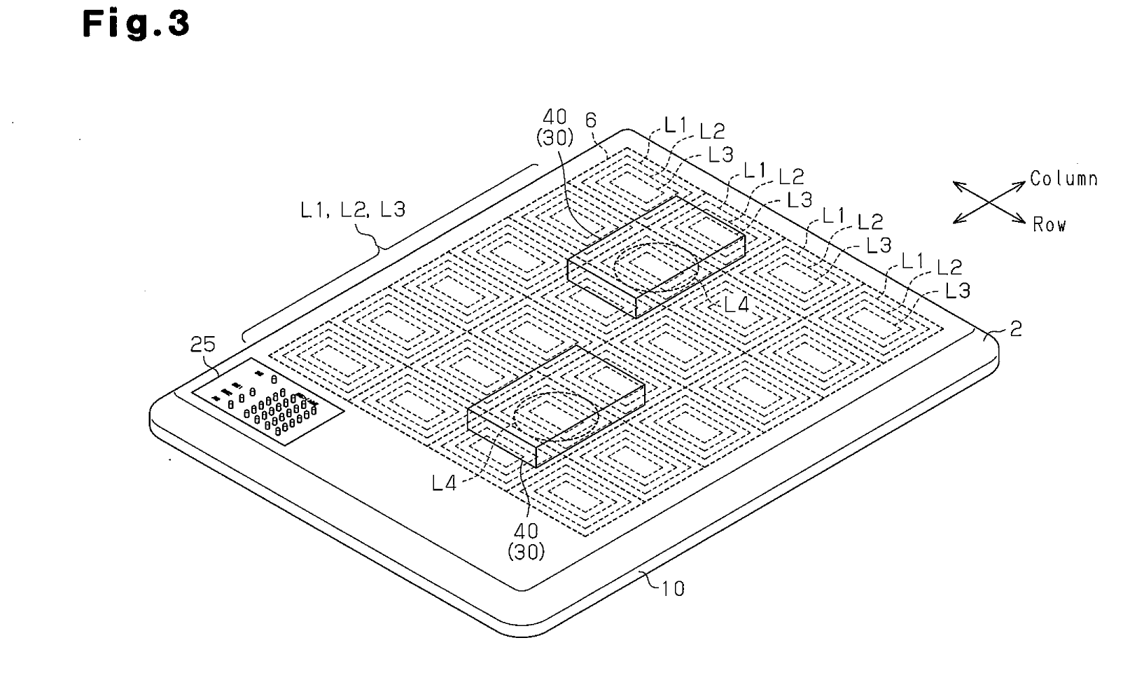

As shown in FIG. 2, the power supplying device 10 is enclosed by a flat frame 2. The frame 2 includes an upper surface defining a power supplying surface 6 on which the portable terminal 40 is set. As shown in FIG. 3, the power supplying surface 6 has an area set to allow for a plurality of portable terminals 40 to be set.

Twenty-four coil units are arranged along the entire power supplying surface 6 in the frame 2. Each coil unit includes a power supplying coil L1, a primary verification coil L2, and a primary foreign object detection coil L3. The twenty-four coil units are arranged on the power supplying surface 6 forming a matrix of four rows and fix columns.

As shown in FIG. 1, the power supplying device 10 includes a single common unit 11, a plurality of (twenty four in the present example) power supplying units 15 connected to the common unit 11, and an indicator 25. The indicator 25 is arranged on the surface of the frame 2.

The common unit 11 includes a power circuit 13, a common control circuit 12, and a nonvolatile memory 14.

The memory 14 stores an ID code that is unique to the power receiving device 30 and registered in advance.

The power circuit 13 converts AC power from an external power source to an appropriate DC voltage and supplies the DC voltage as operational power to each power supplying unit 15 and the common unit 11.

The common control circuit 12 is formed by a microcomputer. The common control circuit 12 transmits a command signal to each power supplying unit 15 and centrally controls the power supplying device 10.

Each power supplying unit 15 includes a unit control circuit 19, an excitation drive circuit 16, a current detection circuit 17, a primary verification circuit 18, a foreign object detection circuit 21, and a signal extraction circuit 22. The excitation drive circuit 16 includes a power supplying coil L1. The primary verification circuit 18 includes a primary verification coil L2. The foreign object detection circuit 21 is connected to a primary foreign object detection coil L3.

The power supplying coil L1 is connected to the current detection circuit 17. The current detection circuit 17 detects the current flowing through the power supplying coil L1 and provides the detection result to the unit control circuit 19.

The unit control circuit 19 controls the operation of the excitation drive circuit 16 based on a command signal from the common control circuit 12 requesting for the supply of power. The excitation drive circuit 16 generates high-frequency current (AC current) upon receipt of a command signal from the common control circuit 12 and supplies the generated current to the power supplying coil L1. This excites the power supplying coil L1.

The common control circuit 12 sequentially supplies high-frequency current to the power supplying coils L1 via the unit control circuits 19. In this case, the time for supplying the high-frequency current is set to a short time so that an increase in the temperature of an object on the power supplying surface caused by the current is substantially undetected. The unit control circuit 19 detects whether or not an object is present in the proximity of the power supplying coil L1 based on the current detection circuit 17 when the current is supplied. The unit control circuit 19 provides the presence detection result to the common control circuit 12. The unit control circuit 19, the current detection circuit 17, and the power supplying coil L1 form a presence detection unit.

When determining that an object is present on the power supplying surface based on the presence detection result from each power supplying unit 15, the common control circuit 12 provides the unit control circuit 19 with a command signal for transmitting an ID request signal. The command signal is provided only to the unit control circuit 19 that detected the presence of an object. When receiving the command signal, the unit control circuit 19 generates the ID request signal and provides the generated signal to the primary verification circuit 18. The primary verification circuit 18 modulates the ID request signal and transmits the modulated signal to the primary verification coil L2 in a wireless manner.

When an ID signal is received from the power receiving device 30 using electromagnetic induction, the primary verification coil L2 provides the received signal to the primary verification circuit 18. The primary verification circuit 18 demodulates the ID signal and provides the demodulated signal to the unit control circuit 19. The unit control circuit 19 provides an ID code, which is included in the ID signal, to the common control circuit 12. The common control circuit 12 verifies the ID code with the ID code stored in the memory 14. When ID code verification is accomplished, the common control circuit 12 excites each power supplying coil L1 in the area corresponding to the power receiving device 30 to supply power. As shown in FIG. 3, when two power receiving devices 30 are arranged on the power supplying surface 6, the ID code is verified for each power receiving device 30. When each ID code is verified, the two power receiving devices 30 are simultaneously supplied with power. In this case, the power supplying coils L1 are not excited where the power receiving device 30 is not detected. The common control circuit 12, the unit control circuit 19, the primary verification circuit 18, and the primary verification coil L2 form a verification unit.

Referring to FIG. 1, the unit control circuit 19 controls the operation of the foreign object detection circuit 21 based on a signal from the common control circuit 12 requesting for the detection of a foreign object. The foreign object detection circuit 21 generates high-frequency current (high-frequency signal) when receiving the command signal from the unit control circuit 19 and supplies the generated current to the primary foreign object detection coil L3. This excites the primary foreign object detection coil L3. Accordingly, a high-frequency signal is transmitted from the primary foreign object detection coil L3. The primary coil L1 and the primary foreign object detection coil L3 are excited at different frequencies.

The high-frequency signal provided to the primary foreign object detection coil L3 undergoes load modulation performed by the power receiving device 30 so that the amplitude changes between two values in predetermined cycles. When a foreign object of metal or the like is present between the primary foreign object detection coil L3 and the power receiving device 30, the cycle in which the amplitude changes between two values is prolonged. The signal extraction circuit 22 detects the high-frequency signal and provides a detection signal to the unit control circuit 19. The unit control circuit 19 determines whether or not a foreign object of metal or the like is present from the cycle of the detection signal and provides the determination result to the common control circuit 12. The unit control circuit 19, the foreign object detection circuit 21, the signal extraction circuit 22, and the primary foreign object detection coil L3 form a foreign object detection unit.

The structure of the indicator 25 will now be described.

As viewed in FIG. 2, the indicator 25 is arranged on the same plane as the power supplying surface 6 at a front end of the frame 2. The indicator 25 is formed at a location where its display portion would not be hidden when the portable terminal 40 is arranged on the power supplying surface 6.

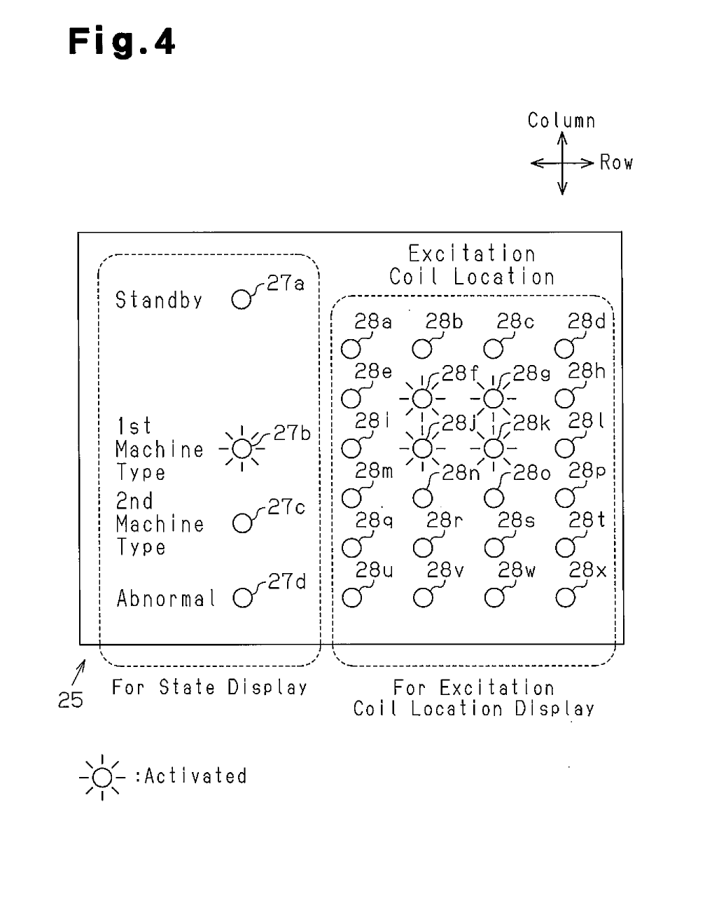

In detail, as shown in FIG. 4, the indicator 25 includes a total of twenty-eight light-emitting diodes, or LEDs 27a to 27d and 28a to 28x. Twenty-four of the LEDs 28a to 28x are arranged in four rows and six columns in correspondence with the layout of the power supplying coils L1. Four of the LEDs 27a to 27d are sequentially arranged at the left side of the twenty-four LEDs 28a to 28x along the longitudinal direction of the twenty-four LEDs 28a to 28x.

In the present example, a diode that emits blue light is employed as the LED 27a, and a diode that emits green light is employed as the LED 27b. A diode that emits orange light is used as the LED 27c, and a diode that emits red light is used as the LED 27d. Diodes that emit blue light are employed as the LEDs 28a to 28x. In this manner, by changing the color of the LEDs, recognition of the display contents of the indicator 25 can be ensured.

When determining from the presence detection result that nothing is arranged on the power supplying surface 6, the common control circuit 12 activates the LED 27a to indicate a standby state. This allows the user to acknowledge that nothing is arranged on the power supplying surface 6 or that the object arranged on the power supplying surface 6 is not recognized in the power supplying device 10.

When determining from the presence detection result that a first power receiving device 30 has been arranged on the power supplying surface 6, the common control circuit 12 deactivates the LED 27a. The common control circuit 12 also activates the LED 27b to indicate that a first machine type has been arranged. Further, when determining from the presence detection result that a second power receiving device 30 has been arranged on the power supplying surface 6, the common control circuit 12 activates the LED 27c, which indicates that a second machine type has been arranged, while keeping the LED 27a activated. This allows the user to acknowledge that an object (power receiving device 30) is arranged on the power supplying surface and that the arranged object is recognized by the power supplying device 10.

When determining from the foreign object detection result that a foreign object of metal or the like is present between a primary foreign object detection coil L3 and a power receiving device 30, the common control circuit 12 activates the LED 27d to indicate an abnormality. In this case, the LEDs 27b and 27c are deactivated. This allows the user to acknowledge that a foreign object of metal or the like is present between a primary foreign object detection coil L3 and the power receiving device 30 so that the user can immediately remove the foreign object.

Based on the presence detection, the common control circuit 12 excites only the power supplying coils L1 in the area where a power receiving device 30 (more accurately, its power receiving coil L4) is present. The common control circuit 12 illuminates the LEDs 28a to 28x corresponding to the locations of the excited power supplying coils L1. This allows to user to acknowledge the power supplying coils L1 that are excited. Further, the user can acknowledge whether or not power is being supplied to the power receiving device 30 arranged on the power supplying surface 6.

The example of FIG. 4 shows the LED 27b and the four LEDs 28f, 28g, 28j, and 28k that are activated in the indicator 25. This allows for visual recognition of the arrangement of a single power receiving device 30 in a range including four power supplying coils L1 corresponding to the four LEDs 28f, 28g, 28j, and 28k and visual recognition of the excitation of four power supplying coils L1.

Power Receiving Device

The power receiving device 30 will now be described. As shown in FIG. 1, the power receiving device 30 includes a rectification circuit 31, a secondary verification circuit 32, a secondary control circuit 33, a memory 34, and a DC/DC converter 35. The rectification circuit 31 is connected to the power receiving coil L4, and the secondary verification circuit 32 is connected to a secondary verification coil L5.

A change in the magnetic flux from a power supplying coil induces AC power in the power receiving coil L4. The rectification circuit 31 rectifies the AC power induced at the power receiving coil L4. The DC/DC converter 35 convert DC voltage from the rectification circuit 31 to a value suitable for operating the portable terminal. The DC voltage is used, for example, to charge a rechargeable battery (not shown), which is an operational power source of the portable terminal.

The secondary control circuit 33 is formed by a microcomputer. The secondary control circuit 33 receives some of the DC power from the rectification circuit 31 for operation. Further, the memory 34 stores an ID code unique to the power receiving device 30.

When an ID request signal is received from a primary verification coil L2 using electromagnetic induction, the secondary verification coil L5 provides the received signal to the secondary verification circuit 32. The secondary verification circuit 32 demodulates the ID request signal and provides the demodulated signal to the secondary control circuit 33. When recognizing the ID request signal, the secondary control circuit 33 generates an ID signal, which includes the ID code stored in the memory 34, and provides the generated signal to the secondary verification circuit 32. The secondary verification circuit 32 modulates the ID signal and transmits the modulated signal in a wireless manner through the secondary verification coil L5.

The power receiving device 30 includes a secondary foreign object detection coil L6, a rectification circuit 36, a multi-vibrator 37, and a transistor 39 that function as a configuration for performing load modulation.

When receiving a high-frequency signal from the primary foreign object detection coil L3 using electromagnetic induction, the secondary foreign object detection coil L6 provides the high-frequency signal to the rectification circuit 36. The rectification circuit 36 rectifies the high-frequency signal. Based on a signal from the rectification circuit 36, the multi-vibrator 37 generates a pulse wave, which includes repetitive Hi and Lo levels, and provides the pulse wave to the transistor 39. The transistor 39 is activated and deactivated by the Hi and Lo levels in the pulse wave. When the transistor 39 is activated, some of the current from the secondary foreign object detection coil L6 flows to ground. Accordingly, the amplitude of the high-frequency signal at the secondary foreign object detection coil L6 changes between two values in fixed cycles in accordance with the activation and deactivation of the transistor 39. This also changes the amplitude of the high-frequency signal at the primary foreign object detection coil L3 between two values in fixed cycles (load modulation).

The presence of a foreign object of metal or the like between the primary foreign object detection coil L3 and the secondary foreign object detection coil L6 decreases the amplitude of the high-frequency signal transmitted and received between the primary foreign object detection coil L3 and the secondary foreign object detection coil L6. This prolongs the repeated cycle of the Hi level and Lo level in the pulse wave generated by the multi-vibrator 37. That is, the switching cycle of the transistor 39 between activated and deactivated states is prolonged. Thus, the cycle is prolonged in which the amplitude of the high-frequency signal transmitted and received between the secondary foreign object detection coil L6 and the primary foreign object detection coil L3 is changed between two values. Accordingly, as described above, the power supplying device 10 can detect a foreign object.

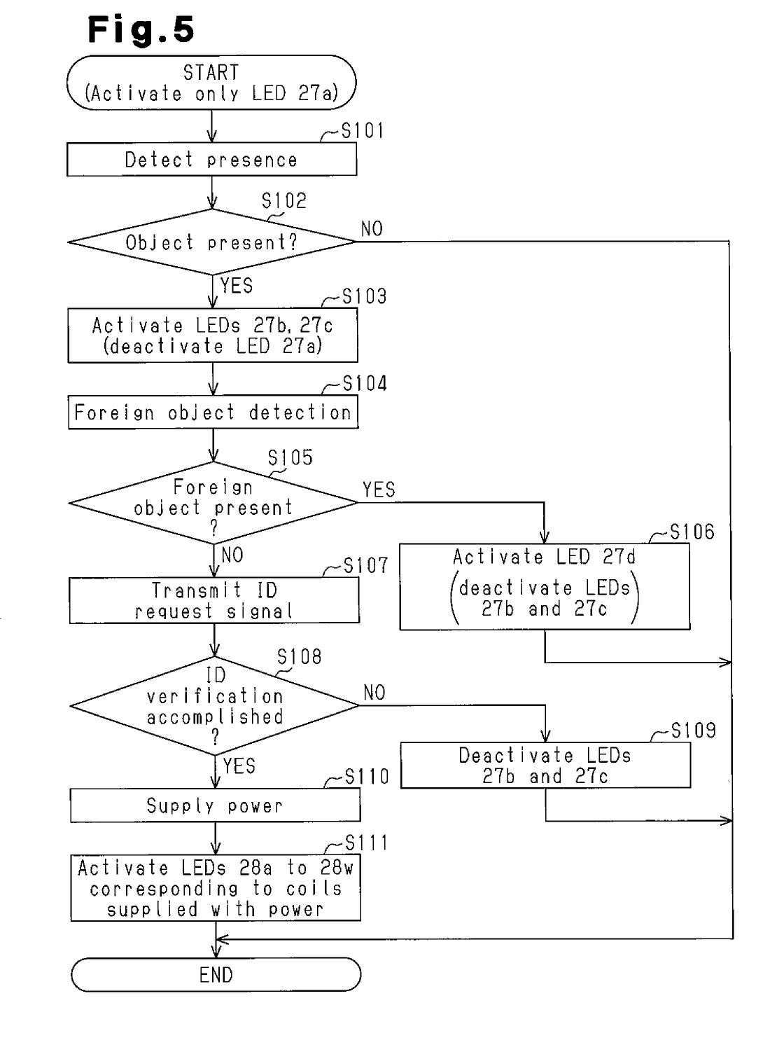

With reference to the flowchart of FIG. 5, the procedures of the processing performed by the common control circuit 12 when supplying power will now be described. The flowchart is executed in fixed cycles. When starting the flowchart, there is nothing arranged on the power supplying surface 6, and the LED 27a is solely activated thereby indicating a standby state.

The common control circuit 12 first performs presence detection with each power supplying unit 15 (S101). When the presence of an object is not detected (S102: NO), the common control circuit 12 ends the processing. More specifically, when nothing is arranged on the power supplying surface 6, the presence detection is performed in each processing cycle of the flowchart. When the presence of an object is detected (S102: YES), the common control circuit 12 deactivates the LED 27a and activates the two LEDs 27b and 27c (S103).

The common control circuit 12 uses each power supplying unit 15 to perform detection of a foreign object of metal or the like (S104). When detecting the presence of a foreign object (S105: YES), the common control circuit 12 activates the LED 27d, which indicates abnormality, and deactivates the two LEDs 27b and 27c (S106) and then ends the processing. When the presence of a foreign object is not detected (S105: NO), the common control circuit 12 transmits an ID request signal through the power supplying units 15 (S107). Then, the ID code included in a received ID signal is verified with the ID code stored in its memory 14 (S108). When the ID code is not verified (S108: NO), the common control circuit 12 determines that the power receiving device 30 is not the authentic one and deactivates the two LEDs 27b and 27c (S109) and then ends the processing. This prevents power from being supplied to devices other than the authentic power receiving device 30. When the ID code is verified (S108: YES), the common control circuit 12 starts supplying power to the power supplying coils L1 corresponding to the area in which the power receiving device 30 is present (S110). The common control circuit 12 selects and activates the LEDs 28a to 28x corresponding to the power supplying coils L1 that are supplying power (S111).

The embodiment described above has the advantages described below.

(1) The user can be notified of information related to the power supplying device 10 with the indicator 25. More specifically, the user can acknowledge from the activation of the LED 27a that there are no objects arranged on the power supplying surface.

Further, the user can acknowledge from the activation of the two LEDs 27b and 27c that the power receiving device 30 or the like is arranged on the power supplying surface and that the power supplying device 10 has recognized the presence of the power receiving device 30.

The user can also acknowledge from the activation of the LED 27d that a foreign object of metal or the like is present between the power supplying device 10 and the power receiving device 30. Thus, the foreign object can immediately be removed. Further, the user can acknowledge, from the activation of the LEDs 28a to 28x, the power supplying coils L1 that are supplying power. Thus, the user can acknowledge that the power receiving device 30 arranged on the power supplying surface 6 is being supplied with power in a normal manner.

### Second Embodiment

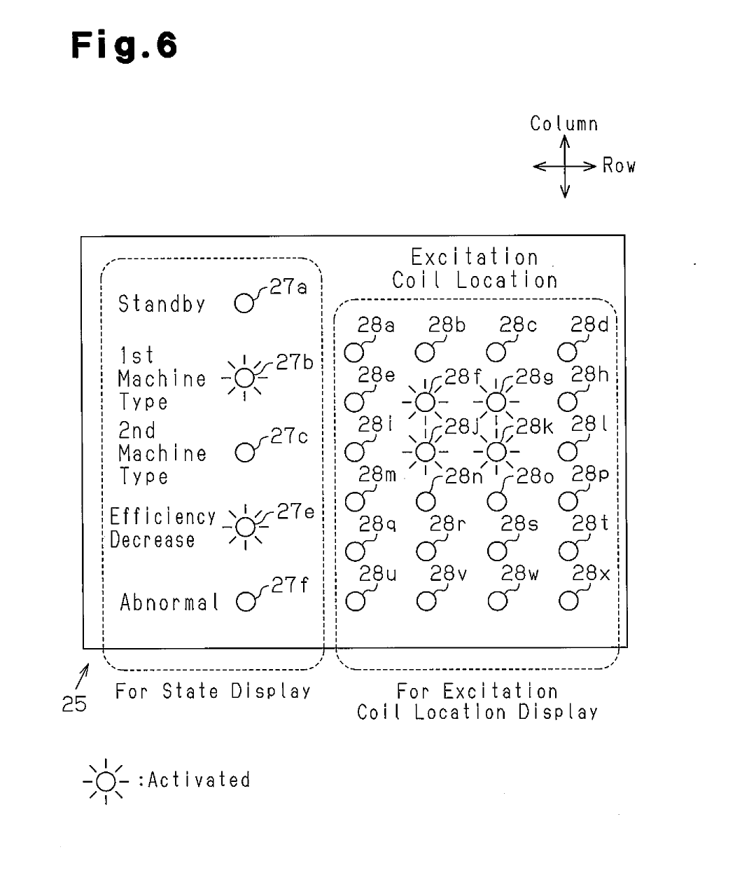

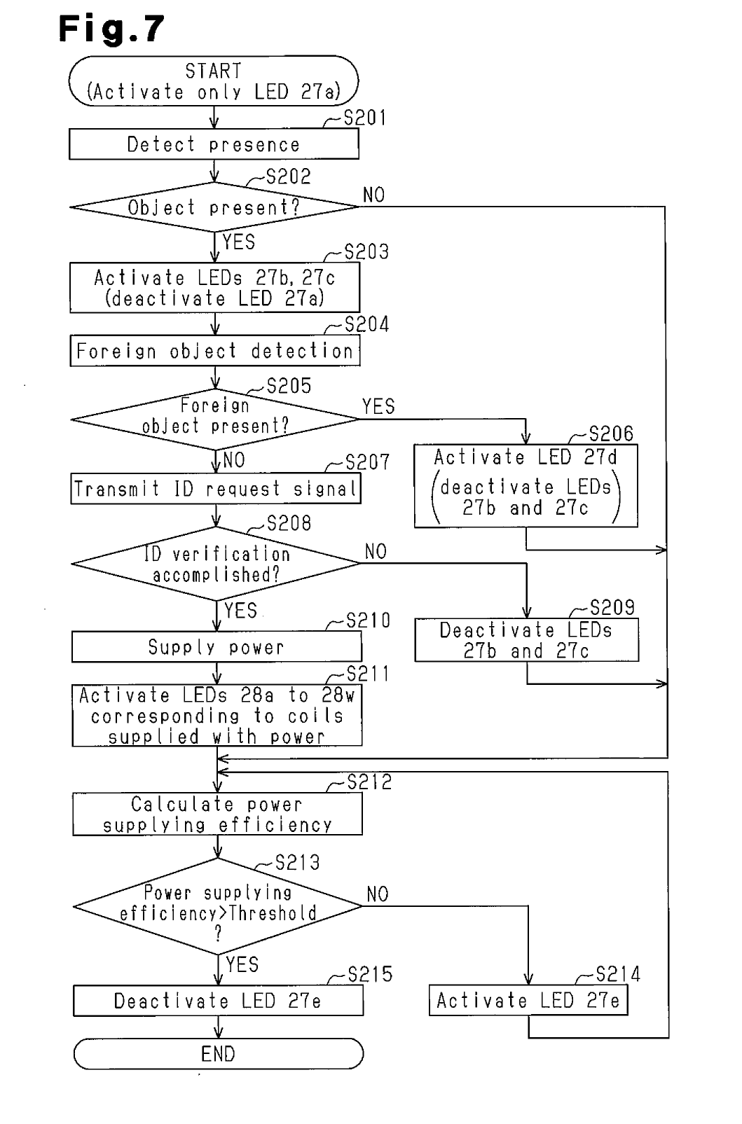

A second embodiment of a contactless power supplying device according to the present invention applied to a contactless power supplying system will now be described with reference to FIGS. 6 and 7. The contactless power supplying system of this embodiment differs from the first embodiment in that there is a notification of a decrease in power supplying efficiency depending on the location where the power receiving device is arranged. The contactless power supplying system of this embodiment has substantially the same structure as the contactless power supplying system of the first embodiment shown in FIG. 1.

As shown in FIG. 6, an LED 27e, which indicates a decrease in power supplying efficiency, is added to the indicator 25. The LED 27e is located between the LED 27c and the LED 27f.

Further, as shown by the single-dashed lines in FIG. 1, the power receiving device 30 includes a received power detection unit 45. The received power detection unit 45 detects the received power supplied from the rectification circuit 31 to the DC/DC converter 35 and outputs the detection result to the secondary control circuit 33.

The secondary control circuit 33 generates, in fixed cycles when receiving power, an information signal including information related to the received power and provides the generated signal to the secondary verification circuit 32.

The secondary verification circuit 32 modulates the information signal and transmits the modulated signal in a wireless manner through the secondary verification coil L5.

The primary verification circuit 18 demodulates the information signal received through the primary verification coil L2 and provides the demodulated signal to the unit control circuit 19. The unit control circuit 19 provides the common control circuit 12 with information related to the received power included in the information signal. The common control circuit 12 recognizes the supplied power based on the number of power supplying coils L1 that are supplying power. The common control circuit 12 calculates the power supplying efficiency based on the supplied power and the received power. Specifically, the power supplying efficiency (%) is calculated as “received power/supplied power×100.” When determining that the calculated power supplying efficiency is less than or equal to a threshold, the common control circuit 12 activates the LED 27e, which indicates that the power supplying efficiency is decreasing. When determining that a re-calculated power supplying efficiency exceeds the threshold, the common control circuit 12 deactivates the LED 27e.

The power supplying efficiency decreases when the power receiving coil L4 is located between two power supplying coils L1. It is considered that this is because the magnetic fluxes from the two power supplying coils L1 cancel each other. When recognizing from the activated LED 27e that the power supplying efficiency is low, the user moves the power receiving device 30 to a different location to improve the power supplying efficiency. When the power receiving device 30 is moved to a predetermined position, the LED 27e is deactivated. The predetermined position is, for example, a position where the power receiving coil L4 and a power supplying coil L1 are directly opposed to each other. The user acknowledges from the deactivation of the LED 27e that the power supplying efficiency has been improved and keeps the power receiving device 30 at the predetermined position described above. This configuration allows for power to be supplied with further efficiency. In this example, the common control circuit 12 forms an efficiency calculation unit.

With reference to the flowchart of FIG. 7, the procedures of the processing performed by the common control circuit 12 when supplying power will now be described. The flowchart is executed in fixed cycles. In the flowchart, steps 5201 to 5211 are similar to the processing performed in steps 5101 to 5111 of FIG. 5. Thus, steps 5201 to 5211 will not be described.

The common control circuit 12 activates the ones of the twenty-four LEDs 28a to 28x corresponding to the power supplying coils L1 that are supplying power (S211) and then calculates the power supplying efficiency when receiving an information signal including information related to the received power (S212). The common control circuit 12 determines whether or not the calculated power supplying efficiency exceeds the threshold (S213). When determining that the calculated power supplying efficiency is less than or equal to the threshold (S213: NO), the common control circuit 12 activates the LED 27e (S214). When an information signal is received again, the common control circuit 12 calculates the power supplying efficiency (S212) and compares the power supplying efficiency with the threshold (S213).

When determining that the calculated power supplying efficiency has exceeded the threshold (S213: YES) and the LED 27e is activated, the common control circuit 12 deactivates the LED 27e (S215). When the LED 27e is deactivated, this state is maintained. This ends the processing.

The embodiment described above has the following advantage in addition to advantage (1) of the first embodiment.

(2) When the power receiving device 30 is arranged on the power supplying surface 6 in a state in which the power supplying efficiency is low, the user is notified of the low power supplying efficiency through the activation of the LED 27e. This allows the user to move the power receiving device 30 to a different location and thereby improve the power supplying efficiency. The LED 27e is deactivated when the power receiving device 30 is moved to a predetermined position. The predetermined position is, for example, a position where the power receiving coil L4 and a power supplying coil L1 are directly opposed to each other. The user acknowledges from the deactivation of the LED 27e that the power supplying efficiency has been improved and keeps the power receiving device 30 at the predetermined position described above. This configuration allows for power to be supplied with further efficiency.

The above embodiments can be modified as described below.

In each of the above embodiments, the LEDs 27b and 27c, which indicate that the first and second machine types have been arranged on the power supplying surface 6, are activated based on the presence detection result. However, the common control circuit 12 may activate the two LEDs 27b and 27c when determining that the ID code has been verified. This allows for the LEDs 27b and 27c to be activated only when the authentic power receiving device 30 is arranged on the power supplying surface 6.

In each of the above embodiments, the five LEDs 27a to 27e and the twenty-four LEDs 28a to 28x may be flashed. For example, by flashing the LED 27d, which indicates an abnormality, or the LED 27e, which indicates that the power supplying efficiency has decreased, the user can be prompted to be careful. Further, the flashing time may be varied in accordance with the power supplying efficiency state or the like.

The display contents of the indicator 25 are not limited to that of the above embodiments. Any one of the five LEDs 27a to 27e and the twenty-four LEDs 28a to 28x may be omitted. Further, for example, an LED that indicates that the charging of the portable terminal 40 may be added. In this case, the power receiving device 30 transmits an information signal indicating that charging has been completed. When recognizing the information signal indicating the completion of charging, the common control circuit 12 activates the LED that indicates the completion of charging. Further, an LED that indicates the occurrence of an abnormality in the power supplying device 10 may be added. Also, an LED that indicates the ID code verification result may be added.

Further, the twenty-four LEDs 28a to 28x may be changed to a single LED, and the LED may be activated only when power is being supplied. This allows for the indicator 25 to be further compact.

In the same manner as the LEDs 28a to 28x, LEDs corresponding to the power supplying coils L1 may be added to the indicator 25. The newly added LEDs may be activated to indicate the area in which the power receiving device 30 is arranged. Even when LEDs are not added, the LEDs 28a to 28x corresponding to where the power receiving device 30 is arranged may be flashed, and the LEDs 28a to 28x corresponding to the power supplying coil L1 that are supplying power may be flashed. In other words, the user may acknowledge a state in which the power receiving device 30 is arranged and a state in which the power receiving device 30 is further supplied with power in this state from the flashing state or illuminating state of the LEDs 28a to 28x.

In each of the above embodiments, the indicator 25 notifies the user of the state of the power supplying device. However, there is no such limitation as long as the user can be notified. For example, voice or vibration may be used to generate a notification for the user. The voice includes a buzzer. In this case, as shown by the single-dashed lines, a speaker 50 or a vibration element 51 may be arranged in lieu of the indicator 25. The common control circuit 12 notifies the user of the state of the power supplying device 10 with voice generated by the speaker 50. Further, the common control circuit 12 notifies the user of the state of the power supplying device 10 by vibrating the vibration element 51.

When the user is provided with a notification through vibration generated with the vibration element 51, the vibration number and vibration cycle may be varied to indicate that the power receiving device 30 has been arranged or that power supplying has started. When the user is provided with a notification through voice generated by the speaker 50, the number of the coil that is supplying power is notified. For example, the coil number may be printed in the area corresponding to each power supplying coil L1 in the power supplying surface 6.

Further, a notification may be generated by combining the display of the indicator 25 with voice and vibration. In this case, at least two of the indicator 25, speaker 50, and vibration element 51 is arranged in the power supplying device 10. This further ensures that the user is notified of the state of the power supplying device.

In particular, when activating the LED 27e, which indicates that the power supplying efficiency has decreased, or the LED 27d, which indicates an abnormality, voice or vibration may also be used to prompt the user to cope immediately.

Further, the power supplying surface 6 may be vibrated when the power receiving device 30 reaches a location where the power supplying efficiency is satisfactory. The vibration may be generated together with a buzzer sound. In this case, the user can perceive the vibration of the power supplying surface 6 through the power receiving device 30. Further, the user can be notified of the power supplying efficiency through changes in the cycle and number of vibration.

In each of the above embodiments, presence detection is performed with the current of each power supplying coil L1. However, a coil for presence detection may be separately arranged. For example, presence detection may be performed with a capacitance sensor. Further, the methods for performing presence detection and foreign object detection are not limited to the methods described above.

In each of the above embodiments, the indicator 25 is formed by cylindrical LEDs. However, light bulbs can be used instead as long as they can be illuminated.

Further, the indicator 25 may be formed by a display, and information similar to that of the indicator 25, such as text, may be shown on the display. For example, in the second embodiment, the power supplying efficiency may be shown by numerals on the display. This allows the user to refer to the power supplying efficiency when moving the power receiving device 30 so that the user can acknowledge which direction the power receiving device 30 should be moved to improve the power supplying efficiency.

The location where the indicator 25 is arranged is not limited to that of the above embodiments. For example, the indicator 25 may be formed on the side surface of the frame 2 in the power supplying device 10. The indicator 25 may also be arranged near and independently from the frame 2. This ensures that the display of the indicator 25 is not hidden by the portable terminal 40, which is arranged on the power supplying surface 6.

Further, the indicator 25 may include a display surface (surface on which LEDs are arranged) that is inclined toward the user. This improves the visibility of the indicator 25.

In each of the above embodiments, the number of the power supplying coils L1 may be changed in accordance with the number of the LEDs 28a to 28x.

In the above embodiments, the unit control circuits 19 may be omitted. In this case, the common control circuit 12 also executes the control executed by the unit control circuits 19. Further, part of the control performed by the unit control circuits 19 may be performed by the common control circuit 12, and part of the control performed by the common control circuit 12 may be performed by the unit control circuits 19.

In the above embodiments, when determining that a foreign object is present, the common control circuit 12 activates the LED 27d, which indicates an abnormality, and deactivates the LEDs 27b and 27c. However, the activated state of the LEDs 27b and 27c may be maintained.

In each of the above embodiments, the coils L1 to L6 are independently arranged. However, at least either one of the primary verification coils L2 and the primary abnormality detection coil L3 may be shared with the power supplying coils L1, and at least either one of the secondary verification coil L5 and the secondary abnormality detection coil L6 may be shared with the power receiving coil L4. Further, the power supplying coils L1 may be arranged independently, and the primary verification coils L2 and the primary foreign object detection coils L3 may be shared. In the same manner, the power receiving coil L4 may be arranged independently, and the secondary verification coil L5 and the secondary foreign object detection coil L6 may be shared.

1. A contactless power supplying device comprising:
a power supplying surface on which a power supplying device is set;
a plurality of power supplying coils arranged along the power supplying surface, wherein among the power supplying coils, power supplying coils opposing the power receiving device set on the power supplying surface are supplied with alternating current to generate magnetic flux used for electromagnetic induction that supplies power in a contactless manner to the opposing power supplying coils; and
a notification unit that generates a notification of information related to the contactless power supplying device.

2. The contactless power supplying device according to claim 1, further comprising a presence detection unit that detects the presence of one or more objects set on the power supplying surface, wherein the notification unit generates a notification of the information indicating the presence of the object based on a detection result of the presence detection unit.

3. The contactless power supplying device according to claim 1, further comprising a foreign object detection unit that detects whether or not a foreign object is present between the power supplying surface and the power receiving device, wherein the notification unit generates a notification of the information indicating the presence of the foreign object based on a detection result of the foreign detection unit.

4. The contactless power supplying device according to claim 1, wherein the notification unit generates a notification of the information indicating the ones of the power supplying coils being supplied with power.

5. The contactless power supplying device according to claim 1, further comprising an efficiency calculation unit that calculates a power supplying efficiency based on a ratio of supplied power, which is supplied by the contactless power supplying device, and received power, which is received by the power receiving device, wherein the notification unit generates a notification of the information indicating the power supplying efficiency calculated by the efficiency calculation unit.

6. The contactless power supplying device according to claim 5, wherein the efficiency calculation unit receives an information signal related to the received power from the power receiving device and detects the received power based on the received information signal.

7. The contactless power supplying device according to claim 5, wherein
the efficiency calculation unit determines whether or not the power supplying efficiency is less than or equal to a threshold; and
the notification unit generates a notification of the information indicating that the power supplying efficiency is less than or equal to the threshold when determining that the power supplying efficiency calculated by the efficiency calculation unit is less than or equal to the threshold.

8. The contactless power supplying device according to claim 1, further comprising a verification unit that verifies whether or not the power receiving device is authentic, wherein the notification unit generates a notification of the information indicating the verification result of the verification unit.

9. The contactless power supplying device according to claim 1, wherein the notification unit includes an indicator that visually notifies the information.

10. The contactless power supplying device according to claim 1, wherein the notification unit includes a speaker that uses a voice to notify the information.

11. The contactless power supplying device according to claim 1, wherein the notification unit includes a vibration element that vibrates to notify the information.
